(19) United States
(12) Patent Application Publication
(10) Pub. No.: US 2016/0245547 A1
(43) Pub. Date: Aug. 25, 2016

(54) Pressure-type liquid rapid heater

(71) Applicant: NINGBO GOLDEN MOUNTAIN FOODS TECH CO., LTD, Ningbo Zhejiang (CN)

(72) Inventors: Jiancheng Xu, Ningbo, Zhejiang (CN); Ningen Yang, Ningbo, Zhejiang (CN); Jiarui Shang, Ningbo, Zhejiang (CN); Liqi Yu, Ningbo, Zhejiang (CN)

(21) Appl. No.: 14/760,155

(22) PCT Filed: Sep. 4, 2014
(86) PCT No.: PCT/CN2014/085953

§ 371 Date: Jul. 9, 2015

(30) Foreign Application Priority Data
Jan. 14, 2014 (CN) 201420023019.3

(51) Int. Cl. F24H 1/10; A47J 31/56; F24H 9/00; A47J 31/54

(52) U.S. Cl. CPC F24H 1/106; A47J 31/54; A47J 31/56; F24H 9/0021

(57) ABSTRACT

A pressure-type liquid rapid heater includes a heating element shell, an upper cover, an inlet tube, an outlet tube, a heating tube and a lower cover, wherein the heating tube is a coated electrothermal glass tube and mounted in the heating element shell; a pre-heating tube is mounted on an outer wall of the heating element shell; the upper cover and a first inner cover are successively connected with an upper end of the heating element shell; upper ends of the heating tube and the pre-heating tube are fixed through a first silica gel sealing ring; a second inner cover and the lower cover are successively connected with a lower end of the heating element shell; lower ends of the heating tube and the pre-heating tube are fixed through a second silica gel sealing ring the inlet tube and the outlet tube are both connected to the upper cover.

### CROSS REFERENCE OF RELATED APPLICATION

This is a U.S. National Stage under 35 U.S.C 371 of the International Application PCT/CN2014/085953, filed Sep. 4, 2014, which claims priority under 35 U.S.C. 119(a-d) to CN 201420023019.3, filed Jan. 14, 2014.

### BACKGROUND OF THE PRESENT INVENTION

1. Field of Invention

The present invention relates to a heating device, and more particularly to a pressure-type liquid rapid heater.

2. Description of Related Arts

In order to improve the flavor of the coffee, keep the activity of the water and fully dissolve the coffee powder in the hot water, an optimal water temperature to brew the coffee is 83-88° C. and the water avoids boiling and generating bubbles; meanwhile, a certain amount of air needs to be dissolved in the water and the pressure is maintained at 7-15 kgf. Thus, a heating device of a rapid coffee machine requires a pressure and a rapid heating.

Conventionally, a heating component of the rapid coffee machine includes a spiral heating tube or a U-shaped heating tube. As described in the Chinese patent application of CN201320153818.8, the heating component includes the spiral heating tube which rises spirally and a water tube which coils around the spiral heating tube and rises with the spiral heating tube, wherein the water tube and the spiral heating tube are casted in an aluminum shell. As described in the Chinese patent application of CN201020514282.4, the heating component includes the U-shaped heating tube which attaches to a water tube. Besides the main heating tube, an additional heating tube is mounted on an inlet tube. Through heating twice, an outlet water temperature is increased.

The above heating components of the coffee machine work under a normal pressure. The hot water discharged from the water outlet is under the normal pressure. When brewing the coffee, it is failed to fully dissolve the coffee powder in the hot water under the normal pressure, leading to a bad flavor of the coffee.

The above heating components of the coffee machine adopt an aluminum heating tube which has a large volume and a high cost. When the aluminum heating tube is exposed to the hot water, it is liable to generate an incrustation scale. Moreover, it is unhealthy to drink the water containing aluminum ions for a long time.

The above heating components of the coffee machine have a slow heating speed, a long pre-heating time and a large thermal inertia. A temperature probe of the coffee machine has a large drift. The heating components emit a large amount of heat to the surrounding, which leads to an electric energy waste, increases the interior temperature of the coffee machine and accelerates the aging of the interior elements of the coffee machine.

### SUMMARY OF THE PRESENT INVENTION

Accordingly, in order to solve above problems, the present invention provides a pressure-type liquid rapid heater which has good pressure endurance.

The technical solutions of the present invention are described as follows. A pressure-type liquid rapid heater comprises a heating element shell, an upper cover, an inlet tube, an outlet tube, a heating tube and a lower cover, wherein the heating tube is a coated electrothermal glass tube; the heating tube is mounted in the heating element shell; a pre-heating tube is mounted on an outer wall of the heating element shell; the upper cover and a first inner cover are successively connected with an upper end of the heating element shell; an upper end of the heating tube and an upper end of the pre-heating tube are fixed through a first silica gel sealing ring; the first silica gel sealing ring is fixed between the upper cover and the first inner cover; a second inner cover and the lower cover are successively connected with a lower end of the heating element shell; a lower end of the heating tube and a lower end of the pre-heating tube are fixed through a second silica gel sealing ring; the second silica gel sealing ring is fixed between the lower cover and the second inner cover; the inlet tube is connected to the upper cover and intercommunicated with the upper end of the pre-heating tube; the lower end of the pre-heating tube and the lower end of the heating tube are fixed on the lower cover and intercommunicated through the lower cover; and the outlet tube is connected to the upper cover and intercommunicated with the upper end of the heating tube.

Preferably, plugs are respectively fixed on the inlet tube, the outlet tube and a temperature probe. The plugs are cylindrical. The upper cover has plug holes and clamp spring grooves thereon. O-rings and the plugs are successively mounted in the respective plug holes. Clamp springs penetrate into the respective clamp spring grooves to fix the plugs in the plug holes.

Further preferably, two silica gel washers are respectively mounted in the first inner cover and the second inner cover. The lower end and the upper end of the heating tube penetrate into the respective silica gel washers to fix the heating tube in the middle of the heating element shell.

Further preferably, a metal net is mounted in the heating tube, wherein the metal net clings to an inner wall of the heating tube.

Further preferably, a compression ring is mounted in the heating tube; and a detecting point of the temperature probe contacts with the inner wall of the heating tube which an upper end of an electrothermal film of the heating tube corresponds to.

Further preferably, the heating element shell has at least one plane. Two temperature controllers are mounted on the plane and both connected with a controlling circuit. The two temperature controllers comprise an automatic reset temperature controller and a manual reset temperature controller.

In some embodiments, the inlet tube is connected to the lower cover. Two pre-heating tubes are mounted on the heating element shell. The upper cover has an upper guide groove therein to intercommunicate a first pre-heating tube with a second pre-heating tube. The lower cover has an inlet groove therein to intercommunicate the second pre-heating tube with the heating tube.

In some embodiments, the upper cover is connected to the inlet tube. Three pre-heating tubes are mounted on the heating element shell, respectively on three side surfaces of the heating element shell. The lower cover has a lower guide groove therein to intercommunicate a first pre-heating tube with a second pre-heating tube. The upper cover has an upper guide groove therein to intercommunicate the second pre-heating tube with a third pre-heating tube. The third pre-heating tube is connected with a bottom of the heating tube within the lower cover through an inlet groove.

Further preferably, two electrode clamps of the lower end and the upper end of the heating tube respectively stretch out of electrode grooves of the inner covers.

Compared with the conventional technologies, the present invention has following advantages. The cool water is pre-heated. The pre-heating tube collects a thermal radiation emitted by the heating tube through a thermal conduction of the heating element shell to pre-heat the cool water. Accordingly, the present invention saves energy, improves a thermal efficiency and effectively prevents the heating tube from being hot and a temperature rise. Moreover, a power density of the electrothermal film is increased and a volume of the heating tube is decreased.

Through sealing by the silica gel sealing rings and connecting by the plugs, the liquid rapid heater of the present invention is able to work steadily under a water pressure of 7-15 kgf and withstand a pressure test of 40kgf. Moreover, a rapid assembly and disassembly and a convenient replacement are realized through connecting by the plugs.

The silica gel washers on the lower end and the upper end of the heating tube separate the heating tube which is made of glass from the heating element shell, so as to avoid a waste heat loss and realize a good shockproof effect and a good sealing effect.

The temperature probe, which is mounted on an upper end of the inner wall of the heating tube, is able to improve a temperature sensitivity, accurately control an outlet water temperature, rapidly control a dry burning of the heating tube and effectively protect the heating tube.

The two temperature controllers mounted on the heating element shell are able to rapidly detect an abnormal temperature rise of the heating tube, automatically cut off power and accordingly prevent an abnormal dry burning of the heating tube.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pressure-type liquid rapid heater according to a first preferred embodiment of the present invention.

FIG. 2 is an exploded view of the pressure-type liquid rapid heater according to the first preferred embodiment of the present invention.

FIG. 3 is a sectional view of the pressure-type liquid rapid heater according to the first preferred embodiment of the present invention.

FIG. 4 is a sketch view of a combination of a temperature probe, a heating tube and a compression ring according to the first preferred embodiment of the present invention.

FIG. 5 is a structural view of a heating element shell and pre-heating tubes according to a second preferred embodiment of the present invention.

FIG. 6 is a perspective view of an upper cover according to the second preferred embodiment of the present invention.

FIG. 7 is a bottom view of the upper cover according to the second preferred embodiment of the present invention.

FIG. 8 is a perspective view of a lower cover according to the second preferred embodiment of the present invention.

FIG. 9 is a bottom view of the lower cover according to the second preferred embodiment of the present invention.

FIG. 10 is a structural view of the heating element shell and the pre-heating tubes according to a third preferred embodiment of the present invention.

FIG. 11 is a perspective view of the upper cover according to the third preferred embodiment of the present invention.

FIG. 12 is a bottom view of the upper cover according to the third preferred embodiment of the present invention.

FIG. 13 is a perspective view of the lower cover according to the third preferred embodiment of the present invention.

FIG. 14 is a bottom view of the lower cover according to the third preferred embodiment of the present invention.

### DETAILED DESCRIPTION OF THE PREFERRED EMBODIMENT

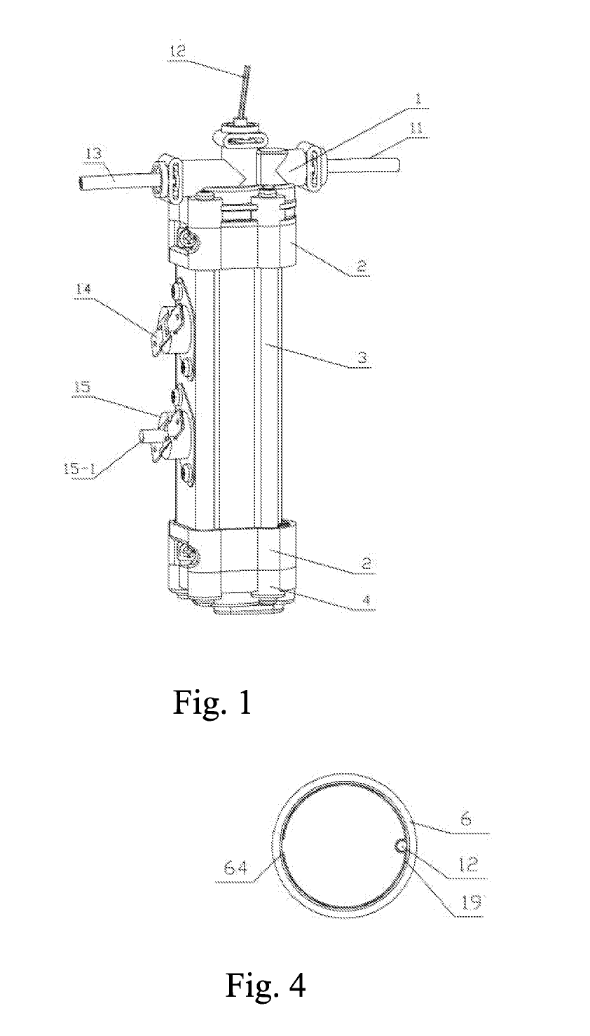

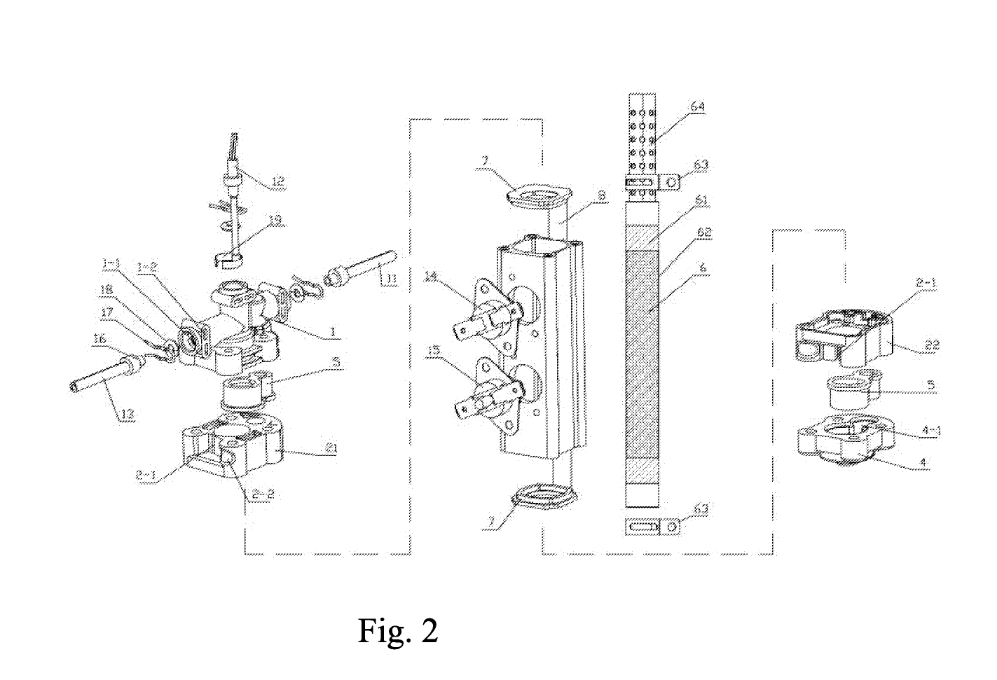

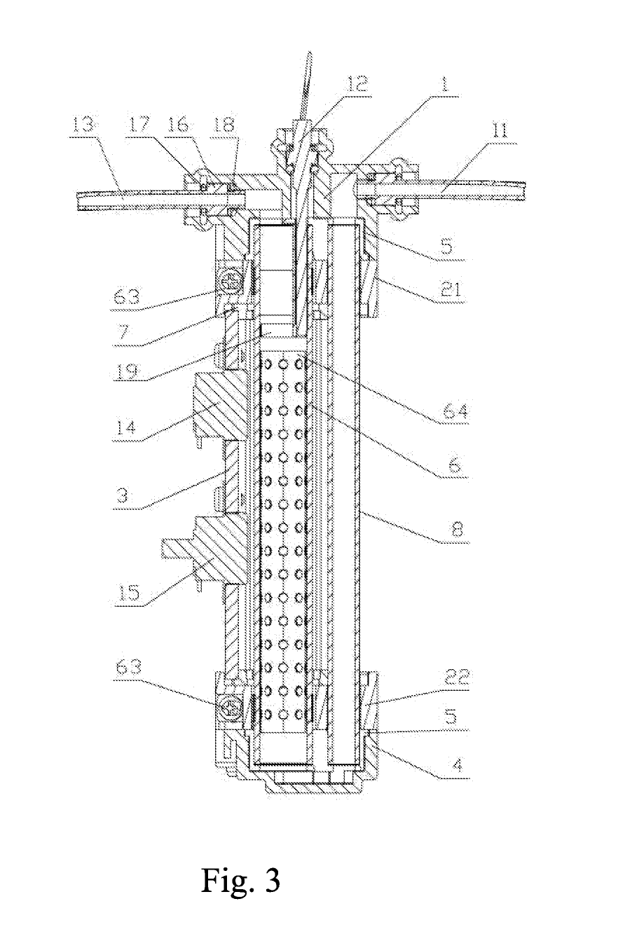

According to a first preferred embodiment of the present invention, as showed in FIG. 1, FIG. 2 and FIG. 3, a pressure-type liquid rapid heater comprises an inlet tube 11, an outlet tube 13, a temperature probe 12, an upper cover 1, two inner covers 2, a heating element shell 3, a lower cover 4, two silica gel sealing rings 5, a heating tube 6, two silica gel washers 7 and a pre-heating tube 8, wherein the inlet tube 11 is connected with a pressure pump which is not showed in figures.

The upper cover 1 is a connecting seat of the inlet tube 11, the outlet tube 13 and the temperature probe 12. The upper cover 1 has three plug holes 1-1 and three clamp spring grooves 1-2 thereon, respectively corresponding to the inlet tube 11, the outlet tube 13 and the temperature probe 12. Plugs 16 are respectively fixed on the inlet tube 11, the outlet tube 13 and the temperature probe 12. The three plugs 16 are cylindrical. The upper cover 1 has the plug holes 1-1 and the clamp spring grooves 1-2 thereon. O-rings 18 and the plugs 16 are successively mounted in the respective plug holes 1-1. Clamp springs 17 penetrate into the respective clamp spring grooves 1-2 to fix the plugs 6 in the plug holes 1-1. The O-rings have a sealing effect. It is easy to disassemble and replace the pressure-type liquid rapid heater. Thus, the pressure-type liquid rapid heater is able to work steadily under a pressure of 7-15 kgf and withstand a water pressure test of more than 40 kgf.

The upper cover 1 has four screw holes thereon. Four first screws are connected with four screw holes of the heating element shell 3 through the screw holes of the upper cover and through the inner cover 2. The four first screws fix the upper cover 1 and the heating element shell 3.

A compression ring 19 is mounted in the heating tube; a detecting point of the temperature probe 12 is inserted into a hole of the compression ring 19, and closely contacts with an inner wall of the heating tube 6 which an upper end of an electrothermal film 62 of the heating tube 6 corresponds to, through the compression ring 19, as showed in FIG. 4.

A first inner cover 21 is connected with the upper cover 1. Through the four first screws, the first inner cover 21 and the upper cover 1 are connected with an upper end of the heating element shell 3. A first silica gel sealing ring 5 is fixed between the upper cover 1 and the first inner cover 21. The lower cover 4 and a second inner cover 22 are connected with a lower end of the heating element shell 3 through four second screws. A second silica gel sealing ring 5 is fixed between the lower cover 4 and the second inner cover 22.

In the first preferred embodiment of the present invention, the silica gel sealing rings 5 are “8”-shaped, respectively cooperating with upper ends and lower ends of the pre-heating tube 8 and the heating tube 6. Two ends of the first silica gel sealing ring 5 are compressed and fixed between the upper cover 1 and the first inner cover 21; and two ends of the second silica gel sealing ring 5 are compressed and fixed between the lower cover 4 and the second inner cover 22. Thus, a good sealing effect is realized and the silica gel sealing rings 5 are able to withstand a water pressure of more than 40 kgf, which avoids a water leakage of the pre-heating tube 8 and the heating tube 6.

The heating tube 6 is an externally-coated electrothermal tube and made of glass. The electrothermal film 62 is coated on an outer wall of the heating tube 6. The upper end and a lower end of the electrothermal film 62 are coated electrodes 61. Two electrode clamps 63 contact with the respective coated electrodes 61 and stretch out of two electrode grooves 2-1 of the inner covers 2. In order to facilitate fixing the electrode clamps 63 and wires through bolts, each inner cover 2 has a bolt hole 2-2 on a side which is proximate to the respective electrode groove 2-1.

The heating element shell 3 is made of aluminum alloy which has a good thermal conductivity. The heating tube 6 is mounted in the heating element shell 3. The silica gel sealing rings 7 are respectively mounted between the heating element shell 3 and the two inner covers 2 for sealing. The heating element shell 3 has a heating cavity in the middle.

The pre-heating tube 8 is arranged on the heating element shell 3, located at a side of the heating cavity, and is tubular. The pre-heating tube 8 has the same length with the heating tube 6. The FIG. 2 shows the pressure-type liquid rapid heater having one pre-heating tube 8.

The heating element shell 3 has at least one plane. Two temperature controllers are mounted on the plane. The two temperature controllers comprise an automatic reset temperature controller 14 and a manual reset temperature controller 15. The two temperature controllers are both connected with a controlling circuit board. The two temperature controllers monitor a surface temperature of the heating tube 6. If the surface temperature of the heating tube 6 is over a preset temperature, the temperature controllers automatically cut off power and accordingly prevent a dry burning of the heating tube 6. A preset temperature of the automatic reset temperature controller 14 is lower than a preset temperature of the manual reset temperature controller 15. The automatic reset temperature controller 14 is a primary protection and the manual reset temperature controller 15 is a secondary protection. When the heating tube 6 lacks water and has the dry burning, the automatic reset temperature controller 14 firstly starts to cut off a heating circuit and protects the heating tube 6. When the surface temperature of the heating tube 6 is lower than the preset temperature of the automatic reset temperature controller 14, the automatic reset temperature controller 14 resets and recovers a power supply of the heating circuit. If the surface temperature of the heating tube 6 increases fast and is over the preset temperature of the manual reset temperature controller 15, the manual reset temperature controller 15 starts to cut off the heating circuit for the secondary protection. Herein, even if the automatic reset temperature controller 14 resets, the heating circuit is still unable to recover the power supply. The manual reset temperature controller 15 has a reset button 15-1 thereon. When the manual reset temperature controller 15 cuts off the power, it is able to recover the power supply of the heating circuit through the reset button 15-1, which is helpful for repairing.

In order to increase a reaction speed of the temperature controllers, two through-holes are arranged on the heating element shell 3. Probes of the automatic reset temperature controller 14 and the manual reset temperature controller 15 pass through the two through-holes and penetrate into the heating tube 6 at 1 mm-5 mm from the outer wall of the heating tube 6. The surface temperature of the heating tube 6 is measured without a contact with the probes of the temperature controllers. Sealing elements are arranged at joints of the through-holes and the temperature controllers, and able to withstand the water pressure of 40 kgf.

The temperature probe 12 monitors a water temperature and the temperature of the inner wall of the heating tube 6. When the pressure-type liquid rapid heater is in normal operation, the temperature probe 12 controls a power of the heating tube 6 through a circuit controlling board, in such a manner that the water discharged from the outlet tube 13 reaches an optimal temperature. When the heating tube 6 lacks water, the heating tube 6 has the dry burning. The temperatures of the inner wall and the outer wall of the heating tube 6 increase rapidly. When the temperatures of the inner wall and the outer wall of the heating tube 6 reach an upper limit temperature, the temperature probe 12, the manual reset temperature controller 15 and the automatic reset temperature controller 14 detect the abnormal temperature; the circuit controlling board rapidly decreases the power of the heating tube 6, so as to protect the electrothermal film 62 from being damaged by the dry burning.

A metal net 64 is further mounted in the heating tube 6. The metal net 64, due to elasticity, clings to the inner wall of the heating tube 6. The metal net 64 is processed with a rough treatment, and thus more liable to form a vaporization core in a boiling heat transfer, which increases an individual heat transfer coefficient and decreases a gas explosion of boiling water.

The lower cover 4 has an “8”-shaped groove 4-1 therein for mounting the second silica gel sealing ring 5. A guide groove is at a bottom of the “8”-shaped groove 4-1 to intercommunicate the heating tube 6 with the lower end of the pre-heating tube 8.

When the pressure-type liquid rapid heater works, cool water which is pressurized by a pressure pump enters an interior of the pressure-type liquid rapid heater through the inlet tube 11, and then enters the heating tube 6 for heating successively through the pre-heating tube 8 and the lower cover 4. Hot water is discharged through the outlet tube 13. The heating element shell 3 absorbs a thermal radiation emitted by the heating tube 6, and transmits the thermal radiation to the pre-heating tube 8. Then the thermal radiation is absorbed by the cool water in the pre-heating tube 8. Accordingly, a temperature of the heating element shell 3 is decreased, and an energy waste is also decreased; a thermal efficiency of the pressure-type liquid rapid heater is improved by pre-heating the cool water before entering the heating tube 6.

Furthermore, a water inlet of a coffee machine is required to be mounted below the heating tube 6. In order to meet structural requirements of the coffee machine, based on the first preferred embodiment of the present invention, a second preferred embodiment of the present invention is provided.

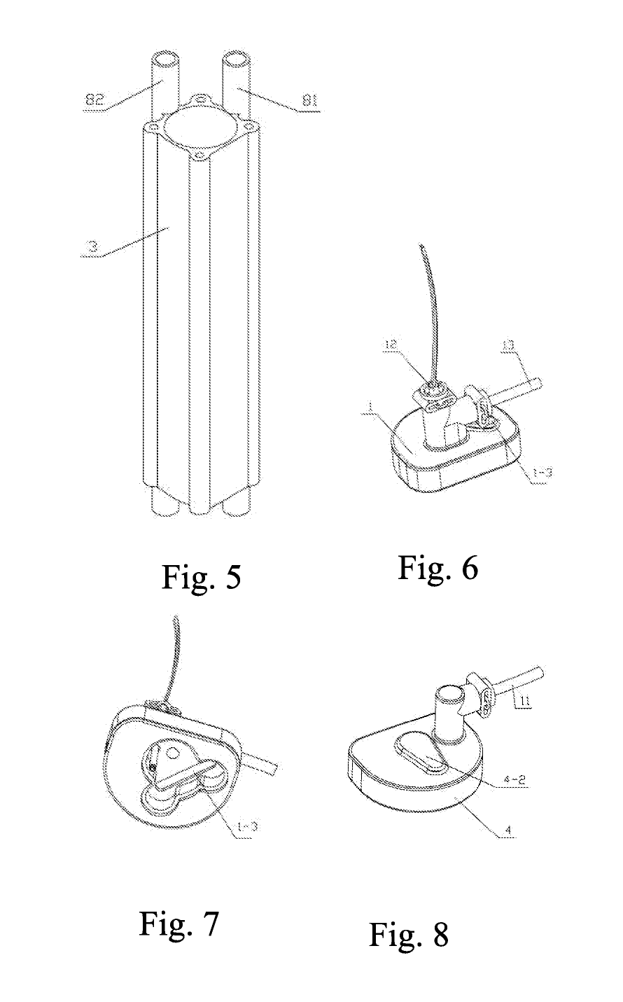

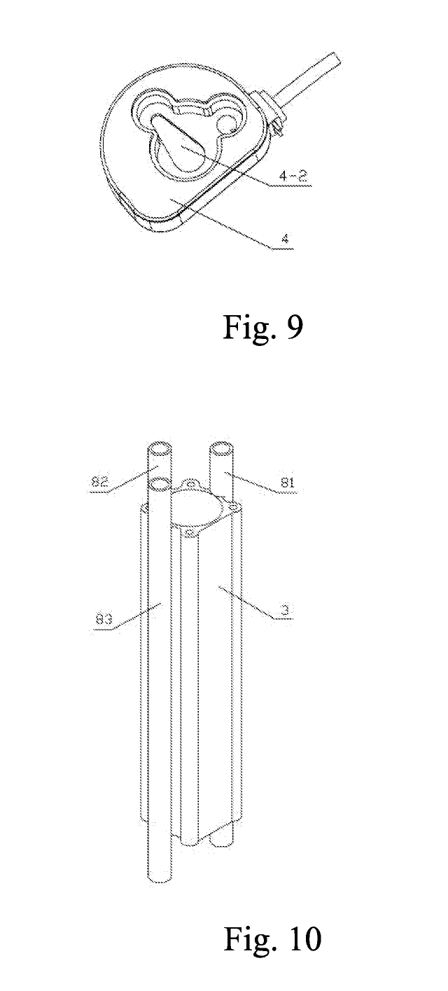

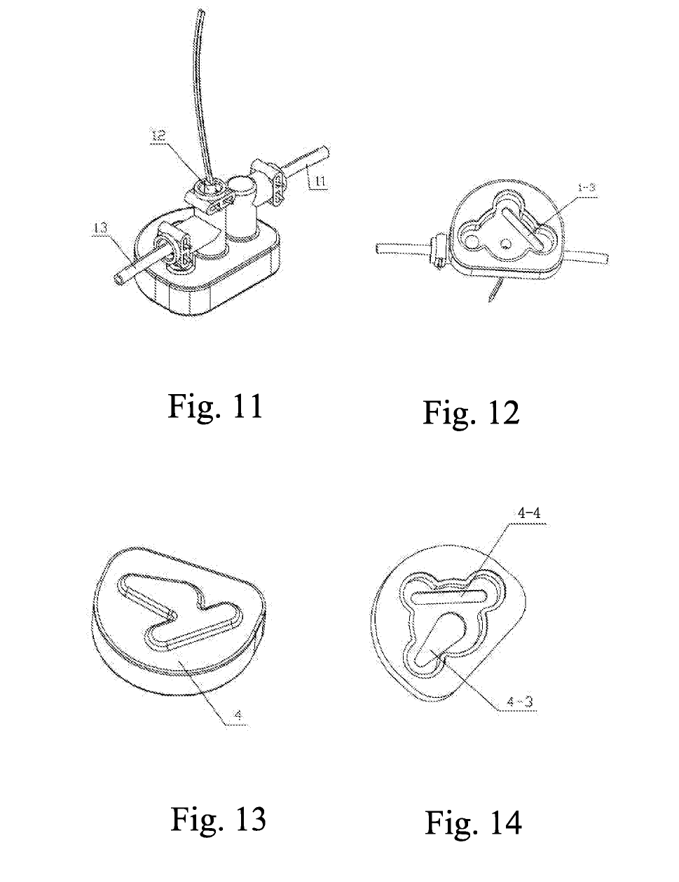

According to the second preferred embodiment of the present invention, combined with the FIG. 5-FIG. 9, the inlet tube 11 is provided on the lower cover 4. Two pre-heating tubes 8 are arranged on the heating element shell 3. The upper cover 1 has an upper guide groove 1-3 therein to connect a first pre-heating tube 81 with a second pre-heating tube 82. Water which passes through the pressure pump successively enters the lower cover 4, the first pre-heating tube 81, the upper cover 1, the second pre-heating tube 82 and the lower cover 4 again, and finally enters the heating tube 6 through a first inlet groove 4-2 for heating. Thus, a requirement of the coffee machines that the water enters below the heating tube 6 is satisfied. Accordingly, a staying time of the water in the pre-heating tubes 8 is increased, a pre-heating effect is improved and a thermal loss is decreased.

Furthermore, in order to better absorb a waste heat emitted by the heating tube 6 through the heating element shell 3, based on the first preferred embodiment, a third preferred embodiment is provided.

According to the third preferred embodiment of the present invention, combined with FIG. 8-FIG. 10, the inlet tube 11 is provided in the upper cover 1. Three pre-heating tubes 8 are arranged on the heating element shell 3, respectively on three side surfaces of the heating element shell 3. The lower cover 4 has a lower guide groove 4-2 therein to connect a first pre-heating tube 81 with a second pre-heating tube 82. The upper cover 1 has an upper guide groove 1-3 therein to connect the second pre-heating tube 82 with a third pre-heating tube 83. The third pre-heating tube 83 is intercommunicated with a bottom of the heating tube 6 within the lower cover 4 through a second groove 4-3.

Water which passes through the pressure pump successively enters the first pre-heating tube 81 through the upper cover 1, the lower cover 4, the second pre-heating tube 82, the upper cover 1, the third pre-heating tube 83 and the lower cover 4 again, and finally enters the heating tube 6. After being heated by the heating tube 6, the water is discharged from the outlet tube 13 of the upper cover 1.

Compared with the second preferred embodiment and the first preferred embodiment, the third preferred embodiment is more complex and expensive. However, a pre-heating time of the water is longer and the pre-heating effect is better. According to the third preferred embodiment of the present invention, the water is heated through the waste heat of the heating tube 6 to greatest extent, so as to increase the heating efficiency of the pressure-type liquid rapid heater and save electricity.

The second preferred embodiment and the third preferred embodiment have the same connection structures between the inner covers 2 and the upper cover 1, the lower cover 4, the heating tube 6 and the pre-heating tubes 8 with the first preferred embodiment. Through the silica gel sealing rings 5, a sealing performance and pressure endurance are improved. The second preferred embodiment and the third preferred embodiment have the same structure of the heating tube 6 with the first preferred embodiment.

The pressure-type liquid rapid heater of the present invention is applicable to a pressure-type coffee machine, a water boiler and a humidifier.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pressure-type liquid rapid heater, comprising a heating element shell, an upper cover, an inlet tube, an outlet tube, a heating tube and a lower cover, wherein:
said heating tube is a coated electrothermal glass tube and mounted in said heating element shell;
at least one pre-heating tube is mounted on an outer wall of said heating element shell;
said upper cover and a first inner cover are successively connected with an upper end of said heating element shell;
an upper end of said heating tube and an upper end of said pre-heating tube are fixed through a first silica gel sealing ring;
said first silica gel sealing ring is fixed between said upper cover and said first inner cover;
a second inner cover and said lower cover are successively connected with a lower end of said heating element shell;
a lower end of said heating tube and a lower end of said pre-heating tube are fixed through a second silica gel sealing ring;
said second silica gel sealing ring is fixed between said lower cover and said second inner cover;
said inlet tube is connected to said upper cover and intercommunicated with said upper end of said pre-heating tube;
said lower end of said pre-heating tube and said lower end of said heating tube are fixed on said lower cover and intercommunicated through said lower cover; and
said outlet tube is connected to said upper cover and intercommunicated with said upper end of said heating tube.

2. The pressure-type liquid rapid heater, as recited in claim 1, wherein plugs are respectively fixed on said inlet tube, said outlet tube and a temperature probe; said plugs are cylindrical; said upper cover has plug holes and clamp spring grooves thereon; O-rings and said plugs are successively mounted in said plug holes; and clamp springs penetrate into said clamp spring grooves to fix said plugs in said plug holes.

3. The pressure-type liquid rapid heater, as recited in claim 1, wherein silica gel washers are respectively mounted in said first inner cover and said second inner cover; and said lower end and said upper end of said heating tube penetrate into said silica gel washers to fix said heating tube in the middle of said heating element shell.

4. The pressure-type liquid rapid heater, as recited in claim 1, wherein a metal net is mounted in said heating tube and said metal net clings to an inner wall of said heating tube.

5. The pressure-type liquid rapid heater, as recited in claim 1, wherein a compression ring is mounted in said heating tube; a detecting point of said temperature probe, through said compression ring, contacts with said inner wall of said heating tube which an upper end of an electrothermal film of said heating tube corresponds to.

6. The pressure-type liquid rapid heater, as recited in claim 1, wherein said heating element shell has at least one plane; two temperature controllers are mounted on said plane; said two temperature controllers are both connected with a controlling circuit; and said two temperature controllers are an automatic reset temperature controller and a manual reset temperature controller.

7. The pressure-type liquid rapid heater, as recited in claim 1, wherein said inlet tube is connected to said lower cover; two pre-heating tubes are mounted on said heating element shell; said upper cover has an upper guide groove therein to intercommunicate a first pre-heating tube with a second pre-heating tube; and said lower cover has a first inlet groove therein to intercommunicate said second pre-heating tube with said heating tube.

8. The pressure-type liquid rapid heater, as recited in claim 1, wherein said upper cover has said inlet tube; three pre-heating tubes are mounted on said heating element shell, respectively on three side surfaces of said heating element shell; said lower cover has a lower guide groove therein to intercommunicate a first pre-heating tube with a second pre-heating tube; said upper cover has an upper guide groove therein to intercommunicate said second pre-heating tube with a third pre-heating tube; and said third pre-heating tube is intercommunicated with a bottom of said heating tube within said lower cover through a second inlet groove.

9. The pressure-type liquid rapid heater, as recited in claim 1, wherein two electrode clamps of said lower end and said upper end of said heating tube respectively stretch out of electrode grooves of said inner covers.
